(19) United States
(12) Patent Application Publication
(10) Pub. No.: US 2018/0290867 A1
(43) Pub. Date: Oct. 11, 2018

(54) ELEVATION APPARATUS TO RAISE A CONNECTION LINE

(71) Applicant: Innovative Manufacturing, Inc., Kirkville, NY (US)

(72) Inventor: Donald L. Metz, Kirkville, NY (US)

(21) Appl. No.: 15/947,728

(22) Filed: Apr. 6, 2018

Related U.S. Application Data
(60) Provisional application No. 62/601,976, filed on Apr. 6, 2017.
(60) Provisional application No. 62/558,366, filed on Sep. 14, 2017.

(51) Int. Cl. B66D 3/02; B66D 3/14

(52) U.S. Cl. CPC B66D 3/02; B66F 2700/09; B66D 3/14

(57) ABSTRACT

An elevation apparatus can be used to raise and retain a connection line connected between a piece of moveable equipment and a stationary structure. The connection line has a first end configured to couple with the piece of moveable equipment, and an opposing second end configured to couple with a supply fitting. The elevation apparatus includes a resilient band having a first end and an opposing second end. The first end of the resilient band can be affixed to a mid-span portion of the connection line, and the second end can be stretched and affixed to an object at a height sufficient to impart a first tensioned length to the resilient band, such that the mid-span portion of the band elevates to a first vertical distance. The elevation apparatus further includes a hook configured to be attached to the object and secure the second end of the resilient band.

### CROSS REFERENCE TO RELATED APPLICATION

Reference is made to and this application claims priority from and the benefit of U.S. Provisional Application Ser. No. 62/601,976, filed Apr. 6, 2017, entitled “LIFT APPARATUS FOR A CONNECTION LINE OF A MOVEABLE PIECE OF EQUIPMENT”, and U.S. Provisional Application Ser. No. 62/558,366, filed Sep. 14, 2017, entitled “LIFT APPARATUS FOR A CONNECTION LINE OF A MOVEABLE PIECE OF EQUIPMENT”, which applications are incorporated herein in their entirety by reference.

### FIELD OF THE INVENTION

This disclosure relates generally to an elevation apparatus and, more specifically, to an elevation apparatus for raising a connection line, such as a refrigerator water supply line, a gas supply line, or an electrical power cord.

### BACKGROUND OF THE INVENTION

Household refrigerators having an automatic icemaker include a fitting in the back for a water supply line. The water supply line typically is not included with the purchase of the refrigerator, it is incumbent upon the homeowner or installer to purchase and install the water connection line. As a result, local hardware stores offer many different types of supply lines in various price ranges, such as crosslinked polyethylene (PEX), braided stainless steel, or copper. The supply lines are sold in various lengths, typically from 5-8 feet. Often, consumers purchase the least expensive type of supply line, which is ¼″ PEX tubing.

When installed, the water connection line has several feet of slack or extra length to allow the refrigerator to be pulled out away from the wall without having to disconnect the supply line. When the refrigerator is pushed back in, the extra length of supply line, which is typically coiled on the floor, may interfere with the rollers. The supply line may be pinched, kinked, cracked, abraded, or otherwise damaged.

The damage to the supply line may result in a leak, either immediately or at some point in the future. Leakage from the water connection line can be dangerous because the water supply is pressurized, and therefore the leakage will continue until the water supply is shut off. A small leak could go undetected for weeks, and could cause hundreds or even thousands of dollars of damage to the floor, sub-floor, floor joists, and structural beams.

### SUMMARY OF THE INVENTION

Embodiments of the present invention solve the problem caused by the motion of a piece of equipment interfering with its connection line.

In accordance with one aspect of the disclosure, an elevation apparatus can be used to raise and retain a connection line connected between a piece of moveable equipment and a stationary structure. The connection line has a first end configured to couple with the piece of moveable equipment, and an opposing second end configured to couple with a supply fitting. The elevation apparatus includes a resilient band having a first end and an opposing second end. The first end of the resilient band can be affixed to a mid-span portion of the connection line, and the second end can be stretched and affixed to an object at a height sufficient to impart a first tensioned length to the resilient band, such that the mid-span portion of the band elevates to a first vertical distance. The elevation apparatus further includes a hook configured to be attached to the object and secure the second end of the resilient band.

In one embodiment, the connection line is a refrigerator water supply line connected at the first end to a water supply fitting on the refrigerator, and connected at the second end to a water supply fitting at the stationary structure.

In another embodiment, the connection line is an electrical power cord connected at the first end to the piece of moveable equipment, and configured at the second end to plug into a wall socket.

In other embodiments, the second end of the resilient band can be affixed to the stationary structure, or to the piece of moveable equipment.

In yet another embodiment, lateral movement of the piece of equipment from a first position away from the stationary structure to a second position towards the stationary structure stretches the resilient band to a second tensioned length.

In one embodiment, the resilient band comprises neoprene rubber having a stretch ratio of at least 180%.

In one example, the neoprene rubber has a width in a range between approximately ⅛-inch and ½-inch.

In another example, the neoprene rubber has a textured surface to provide better grip with the connection line.

In accordance with another aspect of the disclosure, an elevation apparatus includes a connection line having a first end configured to connect to a fitting on a piece of moveable equipment, and an opposing second end configured to connect to a stationary supply source. The elevation apparatus further includes a resilient band having a first end and an opposing second end. The first end can be affixed to a mid-span portion of the connection line, and the second end can be stretched and affixed to an object at a height sufficient to impart a first tensioned length to the resilient band, such that the mid-span portion of the band elevates to a first vertical distance.

In accordance with yet another aspect of the disclosure, an elevation apparatus elevates an electrical power cord on a piece of equipment that is moveable from a first position away from a stationary structure, to a second position towards the stationary structure. The elevation apparatus includes a resilient band having a first end and an opposing second end. The first end can be coupled to a mid-span portion of the electrical power cord, and the second end can be coupled to the piece of equipment at a distance sufficient to impart a first tensioned length to the resilient band, such that the mid-span portion of the electrical power cord elevates to a first vertical distance.

In one embodiment, movement of the piece of equipment from the first position to the second position elevates the mid-span portion of the flexible supply line to a second, higher vertical distance.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts an elevation apparatus in accordance with one embodiment of the present invention, in which a piece of moveable equipment is pulled away from a wall;

FIG. 2 depicts an enlarged view of a portion of the elevation apparatus shown in FIG. 1;

FIG. 3 depicts an enlarged view of a portion of the elevation apparatus shown in FIG. 1, with;

FIG. 4 depicts the elevation apparatus of FIG. 1, in which the piece of moveable equipment is pushed toward the wall;

FIG. 5 depicts an elevation apparatus in accordance with a second embodiment of the present invention;

FIG. 6 depicts an elevation apparatus in accordance with a third embodiment of the present invention, in which a piece of moveable equipment is pulled away from a wall;

FIG. 7 depicts an enlarged view of a portion of the elevation apparatus shown in FIG. 5;

FIG. 8 depicts an enlarged view of another portion of the elevation apparatus shown in FIG. 5;

FIG. 9 depicts the elevation apparatus of FIG. 5, in which the piece of moveable equipment is pushed toward the wall;

FIG. 10 depicts an elevation apparatus in accordance with a fourth embodiment of the present invention; and

FIG. 11 depicts an elevation apparatus in accordance with a fifth embodiment of the present invention.

### DETAILED DESCRIPTION OF THE INVENTION

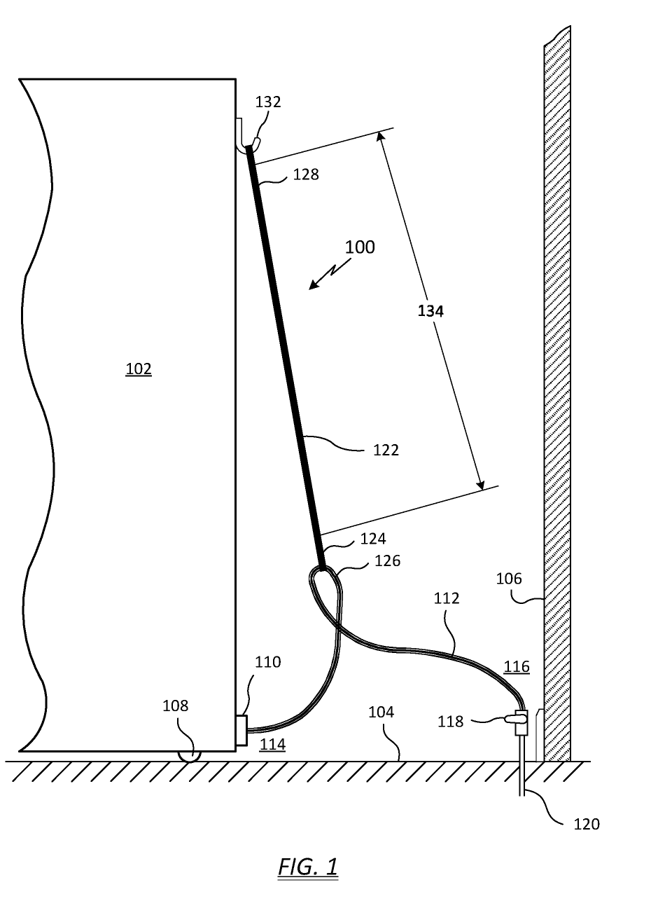

Embodiments of the present invention solve the problem caused by a piece of moveable equipment interfering with its connection line. For example, FIG. 1 depicts an elevation apparatus 100 that prevents a refrigerator 102 from running over or otherwise interfering with its water supply line. The refrigerator 102 is shown sitting on a floor 104, pulled away from a wall 106, as would be the case when cleaning behind the refrigerator or installing the water supply line. The elevation apparatus 100 may be adapted for use with virtually any type of refrigerator having an icemaker and/or water dispenser.

Typically, the refrigerator 102 is installed in between countertop cabinets, pantries, walls, or the like, resulting in limited access to the back side of the refrigerator. For this reason, refrigerator 102 includes roller elements 108 to permit the refrigerator to be easily moved away from the wall 106. The refrigerator 102 further includes a supply fitting 110 adapted to receive a water connection line 112 that is connected to a household water source. In one example, the supply fitting 110 is a ¼-inch compression fitting.

Experiments conducted by the inventor have demonstrated that the water connection line 112 may be any type of line commercially-available for the intended purpose. The connection line 112 may be flexible or rigid. Examples of flexible line include, but are not limited to, polyethylene, cross-linked polyethylene (PEX), or braided hose comprising a braided stainless steel outer sheathing with inner nylon-reinforced vinyl tubing. Examples of rigid line include, but are not limited to, ¼-inch copper tubing. The length of the water connection line 112 will vary depending upon the specific installation, as explained below, but in general a longer hose is useful, for example in the range of 8-10 feet. A first end 114 of the water connection line 112 connects to the supply fitting 110 on the refrigerator, and an opposing second end 116 connects to a water supply fitting 118 on the wall 106. In the illustrated example, the water supply fitting 118 is a quarter-turn shutoff valve. The valve 118 may be connected to copper tubing 120 that taps off a cold-water supply line elsewhere in the home (not shown).

The disclosed elevation apparatus 100 includes a resilient band 122 configured to keep the water connection line 112 elevated off the floor 104 and prevent the line from interfering with the movement of the refrigerator 102. In one example, the resilient band 122 may be formed from a highly-engineered elastomer material, such as neoprene. A first end 124 of the resilient band 122 is secured to a mid-span portion 126 of the water connection line 112 and an opposing second end 128 of the resilient band 122 is secured to an upper portion of the refrigerator 102, at a height above first end 124.

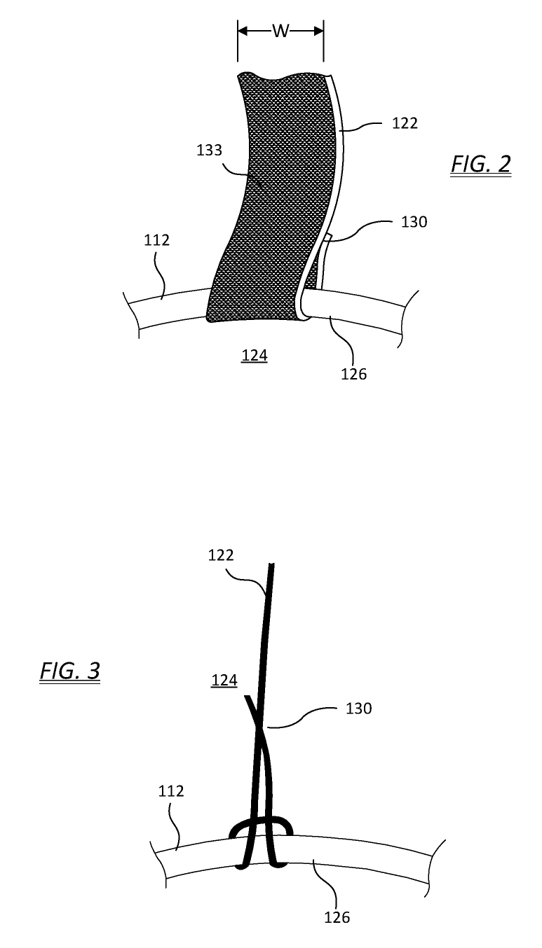

In one example, shown in FIG. 2, the resilient band 122 can have a loop formed on each end 124, 128 by, for example, applying a commercial-grade adhesive 130 to each end. In the illustrated example, if one end of the connection line 112 is free it may be inserted directly through the loop. The loop on the second end 128 of the resilient band 122 can be secured to a hook 132 on the refrigerator 102 (FIG. 1). The hook 132 may be of the variety having an adhesive backing, such as a Command brand utility hook available from the 3M Company, Maplewood, Minn.

The inventor of the present invention experimented with numerous resilient band 122 configurations, such as ⅛- or ¼-inch diameter bungee cord. However, bungee cord tended to slip along the connection line 112, which could potentially prevent the connection line 112 from lifting properly. Furthermore, when the connection line 112 was metal braided hose, the slippage caused the bungee cord to abrade, which could eventually result in a failure of the resilient band. A preferred material selection for the resilient band 122 is neoprene rubber, having a width W in a range between approximately ⅛-inch and ½-inch, a thickness of approximately 1/16-inch, a length of approximately 3 feet, and a stretch ratio of at least 180%. The resilient band 122 may further include a textured surface 133 to provide a better grip with the connection line 112. In one example, the neoprene rubber may include a block or diamond surface texture 133.

In another example, shown in FIG. 3, if neither end of the connection line 112 is free, the resilient band 122 can be secured to the water connection line 112 by way of a cow hitch (also known as a lanyard hitch or lark's head). A loop can be formed on each end 124, 128 of the resilient band 122 by, for example, applying a glue to each end. The resilient band 122 is then placed underneath the mid-span portion 126 of the water connection line 112, the loop of the first end 124 is passed through the loop on the second end 128, and the second end is pulled upwards to tighten the hitch.

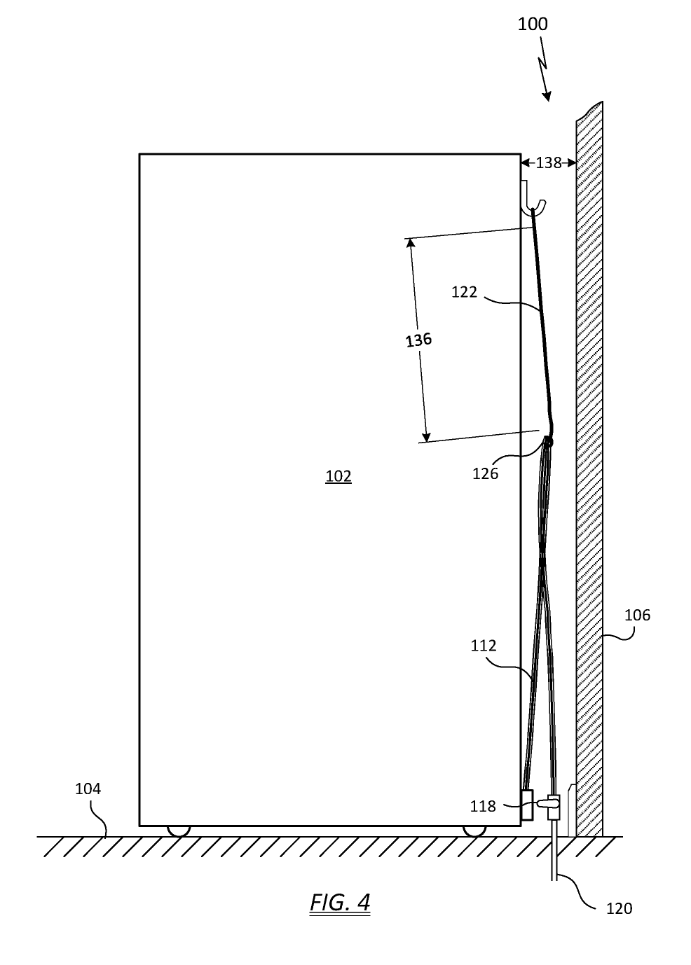

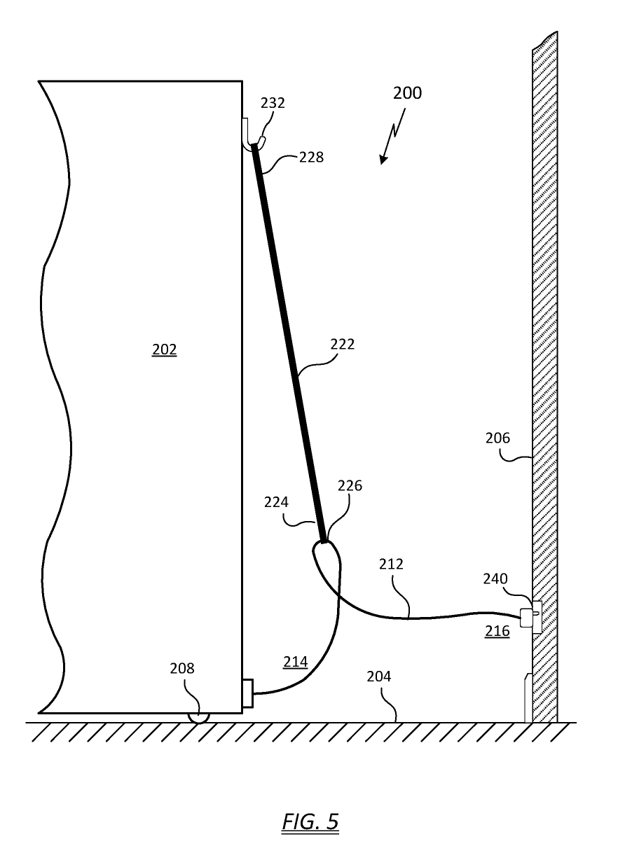

With reference to FIGS. 1 and 4, the resilient band 122 is configured such that when the refrigerator 102 is pulled away from the wall 106, the resilient band 122 is stretched a first tensioned length 134 (FIG. 1) sufficient to lift the water connection line 112 off the floor 104. Furthermore, when the refrigerator 102 is pushed back towards the wall 106, the resilient band 122 is stretched to a second tensioned length 136 (FIG. 4) that is also sufficient to keep the water connection line 112 elevated off the floor 104. In one embodiment of the invention, the second tensioned length 136 is less than the first tensioned length 134, having the end result of lifting the mid-span portion 126 of the water connection line 112 higher as the refrigerator 102 moves towards the wall 106. In this manner, the water connection line 112 will assume a greater and greater vertical orientation and thus will readily fit into the narrow gap 138 behind the installed refrigerator 102.

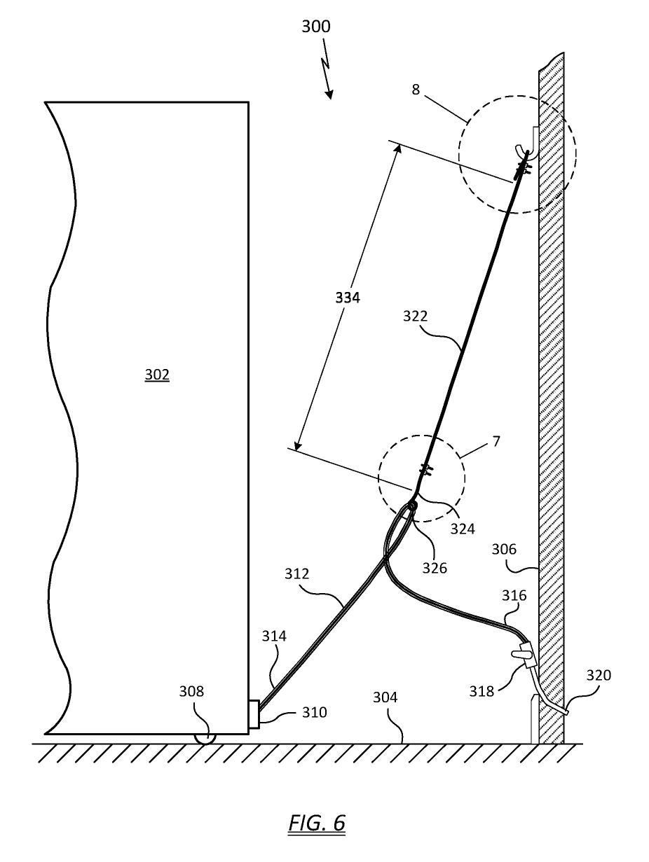

Referring now to FIG. 5, wherein like numerals indicate like elements in FIG. 1, embodiments of the present invention may include an elevation apparatus configured to raise an electrical power cord off the floor to prevent the cord from interfering with a piece of moveable equipment. FIG. 5 depicts an elevation apparatus 200 for use when moving a piece of equipment 202, such as a refrigerator, gas range, or gas dryer, to and from a stationary structure 206 such as a wall. The piece of equipment 202, which may include roller elements 208 for ease of mobility, includes an electrical connection line 212 or power cord that is connected to a wall socket 240. A first end 214 of the power cord 212 connects to the appliance 202, and an opposing second end 216 connects to the wall socket 240.

The disclosed elevation apparatus 200 further includes a resilient band 222 configured to keep the power cord 212 elevated off the floor 204 and prevent the cord from interfering with the movement of the appliance 202. In one example, the resilient band 222 may be the same configuration of neoprene rubber as that disclosed with reference to FIG. 1. In another example, the resilient band 222 may be ⅛″ or ¼″ diameter bungee cord, approximately 4-7 feet in length. A first end 224 of the resilient band 222 is secured to a mid-span portion 226 of the power cord 212. As illustrated in FIG. 3, the resilient band 222 may be secured to the power cord 212 by way of a hitch. An opposing second end 228 of the resilient band 222 is secured to the refrigerator 202 at a height above first end 224. In the illustrated example, the second end 228 of the resilient band 222 is attached to the refrigerator 202 using a hook 232. The hook 232 may be of the variety having an adhesive backing.

In operation, the elevation apparatus 200 works much the same way as the elevation apparatus 100 disclosed in FIG. 1. The resilient band 222 is configured such that when the piece of equipment 202 is pulled away from the wall 206, the resilient band 222 is stretched a first tensioned length sufficient to lift the power cord 212 off the floor 204. Furthermore, when the equipment 202 is pushed back towards the wall 206 (not shown), the resilient band 222 is stretched to a second tensioned length that is also sufficient to keep the power cord 212 elevated off the floor 204. In one embodiment of the invention, the second tensioned length is less than the first tensioned length, having the end result of lifting the mid-span portion 226 of the power cord 212 higher as the equipment 202 moves towards the wall 206. In this manner, the power cord 212 will assume a greater and greater vertical orientation and thus will readily fit into a narrow gap behind the installed equipment 202.

Turning now to FIG. 6, shown is an elevation apparatus 300 that prevents a refrigerator 302 from running over or otherwise interfering with its water supply line. The elevation apparatus 300 is much the same as that disclosed with reference to FIG. 1, except the resilient band 322 is fixed to the wall 306 instead of the refrigerator 302.

The refrigerator 302 stands on a floor 304, pulled away from a wall 306. Typically, the refrigerator 302 is installed in between countertop cabinets, pantries, walls, or the like, resulting in limited access to the back portion of the refrigerator. For this reason, refrigerator 302 includes roller elements 308 to permit the refrigerator to be easily moved away from the wall 306. The refrigerator 302 includes a supply fitting 310 adapted to receive a water connection line 312 that is connected to a household water source. In one example, the supply fitting 310 is a ¼-inch compression fitting.

The water connection line 312 may be any type suited for the purpose, but a hose comprising a braided stainless steel outer sheathing and inner nylon-reinforced vinyl tubing has been found to be the most durable for use in the disclosed invention. The length of the water connection line 312 will vary depending upon the specific installation, as explained below, but in general a longer hose is useful, for example in the range of 8-10 feet. A first end 314 of the water connection line 312 connects to the supply fitting 310 of the refrigerator, and an opposing second end 316 connects to a stationary water supply fitting 318. In the illustrated example, the water supply fitting 318 is a quarter-turn shutoff valve. The valve 318 may be connected to copper tubing 320 that taps off a cold-water supply line (not shown).

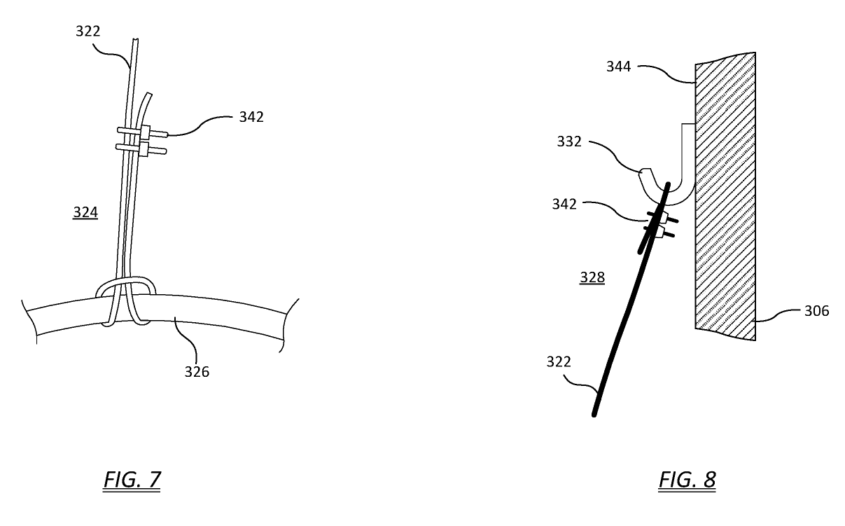

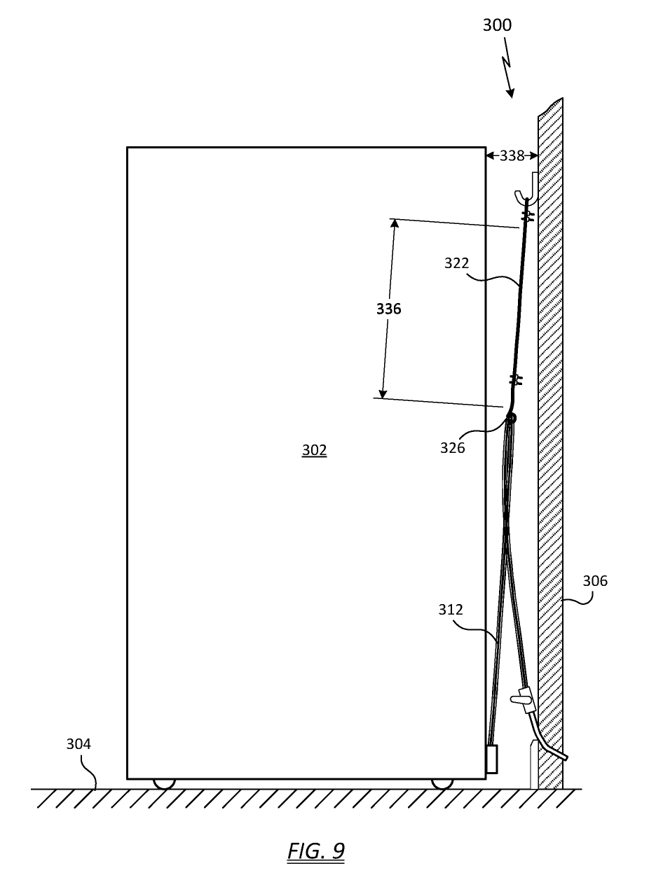

The disclosed elevation apparatus 300 further includes a resilient band 322 configured to keep the water connection line 312 elevated off the floor 304 and prevent the line from interfering with the movement of the refrigerator 302. In one example, the resilient band 322 may be formed from a highly-engineered elastomer material, such as neoprene. The band 322 may have a width W in a range between approximately ⅛-inch and ½-inch, a thickness of approximately 1/16-inch, a length of approximately 3 feet, and a stretch ratio of at least 180%. The resilient band 322 may further include a textured surface (not shown, but similar to FIG. 2) to provide a better grip with the connection line 312. In another example, the resilient band 322 may be ⅛″ or ¼″ diameter bungee cord, approximately 4-7 feet in length. A first end 324 of the resilient band 322 is secured to a mid-span portion 326 of the water connection line 312. In one example, illustrated in FIG. 7, the resilient band 322 may be secured to the water connection line 312 by way of a hitch. A loop can be formed on each end 324, 328 of the resilient band 322 by, for example, applying a glue to each end. The resilient band 322 is then placed underneath the mid-span portion 326 of the water connection line 312, the loop of the first end 324 is passed through the loop on the second end 328, and the second end is pulled upwards to tighten the hitch. Alternatively, instead of glue, the working end 324 of the hitch may be secured to the standing part using one or more zip ties 342. As shown in greater detail in FIG. 8, an opposing second end 328 of the resilient band 322 is secured to a stationary structure 344 at a height above first end 324. In the illustrated example, the second end 328 is attached to the wall 306 using a hook 332. For ease of installation and to prevent drilling holes, the hook 332 may be of the variety having an adhesive backing.

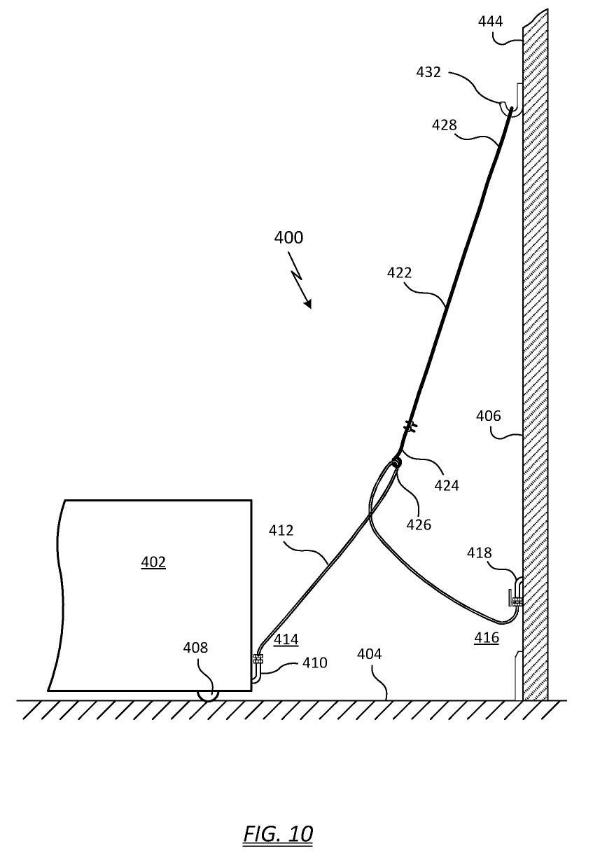

With reference to FIGS. 6 and 9, the resilient band 322 is configured such that when the refrigerator 302 is pulled away from the wall 306 (FIG. 6), the resilient band 322 is stretched a first tensioned length 334 sufficient to lift the water connection line 312 off the floor 304. Furthermore, when the refrigerator 302 is pushed back towards the wall 306 (FIG. 9), the resilient band 322 is stretched to a second tensioned length 336 that is also sufficient to keep the water connection line 312 elevated off the floor 304. In one embodiment of the invention, the second tensioned length 336 is less than the first tensioned length 334, having the end result of lifting the mid-span portion 326 of the water connection line 312 higher as the refrigerator 302 moves towards the wall 306. In this manner, the water connection line 312 will assume a greater and greater vertical orientation and thus will readily fit into the narrow gap 338 behind the installed refrigerator 302.

Referring now to FIG. 10, wherein like numerals indicate like elements in FIGS. 1-4, embodiments of the present invention may include other types of moveable equipment that have a connection to a stationary structure. For example, embodiments may include gas ranges, dryers, or outdoor barbeques having a gas connection line. FIG. 10 depicts an elevation apparatus 400 for use in connecting a moveable piece of equipment 402, such as a gas oven or gas dryer, to a stationary structure 406 such as a wall. The piece of equipment 402, which may include roller elements 408 for ease of mobility, may include a gas supply fitting 410 adapted to receive a gas connection line 412 that is connected to a residential or commercial source of natural gas or propane.

The gas connection line 412 may be any type rated for the purpose, such as vinyl-coated corrugated stainless steel tubing (CSST). A first end 414 of the gas connection line 412 connects to the gas supply fitting 410 of the equipment, and an opposing second end 416 connects to a stationary gas supply fitting 418. In the illustrated example, the gas supply fitting 418 includes a quarter-turn ball valve.

The disclosed elevation apparatus 400 further includes a resilient band 422 configured to keep the gas connection line 412 elevated off the floor 404 and prevent the line from interfering with the movement of the equipment 402. In one example, the resilient band 422 may be formed from a highly-engineered elastomer material, such as neoprene. The band 422 may have a width W in a range between approximately ⅛-inch and ½-inch, a thickness of approximately 1/16-inch, a length of approximately 3 feet, and a stretch ratio of at least 180%. The resilient band 422 may further include a textured surface (not shown, but similar to FIG. 2) to provide a better grip with the connection line 412. In another example, the resilient band 422 may be ⅛″ or ¼″ diameter bungee cord, approximately 4-7 feet in length. A first end 424 of the resilient band 422 is secured to a mid-span portion 426 of the gas connection line 412. Similar to the illustrated embodiment of FIG. 7, the resilient band 422 may be secured to the gas connection line 412 by way of a hitch. A loop can be formed on each end 424, 428 of the resilient band 422 by applying a glue to each end. The resilient band 422 is then placed underneath the mid-span portion 426 of the gas connection line 412, the loop of the first end 424 is passed through the loop on the second end 428, and the second end is pulled upwards to tighten the hitch. Alternatively, instead of glue, the working end 424 of the hitch may be secured to the standing part using one or more zip ties. Similar to the illustrated embodiment of FIG. 8, an opposing second end 428 of the resilient band 422 is secured to a stationary structure 444 at a height above first end 424. In the illustrated example, the band second end 428 is attached to the wall 406 using a hook 432. For ease of installation and to prevent drilling holes, the hook 432 may be of the variety having an adhesive backing.

In operation, the elevation apparatus 400 works much the same way as the elevation apparatus 100 disclosed in FIG. 1. The resilient band 422 is configured such that when the piece of equipment 402 is pulled away from the wall 406, the resilient band 422 is stretched a first tensioned length sufficient to lift the gas connection line 412 off the floor 404. Furthermore, when the equipment 402 is pushed back towards the wall 406, the resilient band 422 is stretched to a second tensioned length that is also sufficient to keep the gas connection line 412 elevated off the floor 404. In one embodiment of the invention, the second tensioned length is less than the first tensioned length, having the end result of lifting the mid-span portion 426 of the gas connection line 412 higher as the equipment 402 moves towards the wall 406. In this manner, the gas connection line 412 will assume a greater and greater vertical orientation and thus will readily fit into a narrow gap behind the installed equipment 402.

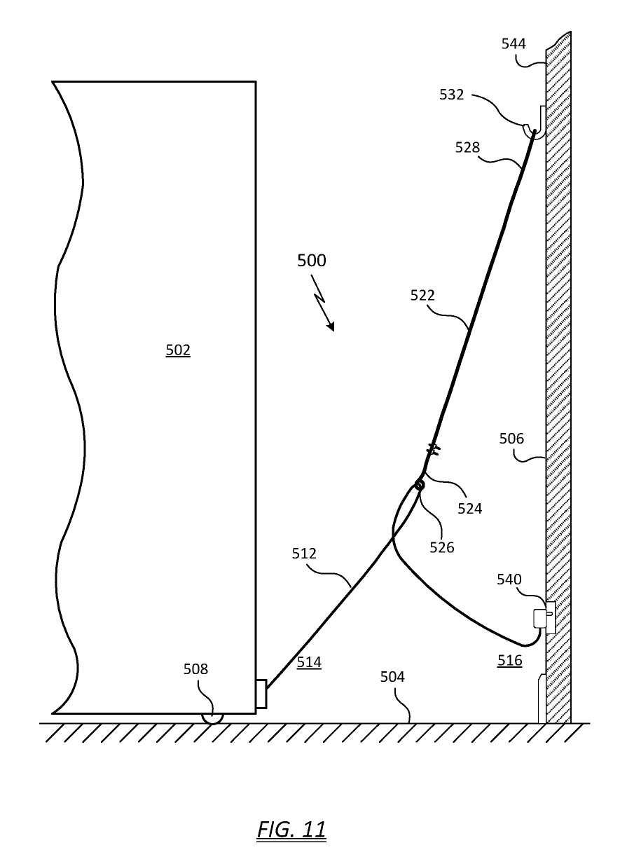

Referring now to FIG. 11, wherein like numerals indicate like elements in FIG. 5, embodiments of the present invention may include an elevation apparatus configured to raise an electrical power cord off the floor to prevent the cord from interfering with a piece of mobile equipment. FIG. 11 depicts an elevation apparatus 500 for use when moving a piece of equipment 502, such as a refrigerator, gas range, or gas dryer, to and from a stationary structure 506 such as a wall. The piece of equipment 502, which may include roller elements 508 for ease of mobility, includes an electrical connection line 512 or power cord that is connected to a wall socket 540. A first end 514 of the power cord 512 connects to the appliance 502, and an opposing second end 516 connects to the wall socket 540.

The disclosed elevation apparatus 500 further includes a resilient band 522 configured to keep the power cord 512 elevated off the floor 504 and prevent the cord from interfering with the movement of the appliance 502. In one example, the resilient band 522 may be formed from a highly-engineered elastomer material, such as neoprene. The band 522 may have a width W in a range between approximately ⅛-inch and ½-inch, a thickness of approximately 1/16-inch, a length of approximately 3 feet, and a stretch ratio of at least 180%. The resilient band 522 may further include a textured surface (not shown, but similar to FIG. 2) to provide a better grip with the power cord 512. In another example, the resilient band 422 may be ⅛″ or ¼″ diameter bungee cord, approximately 4-7 feet in length. A first end 524 of the resilient band 522 is secured to a mid-span portion 526 of the power cord 512. Similar to the illustrated embodiment of FIG. 7, the resilient band 522 may be secured to the gas connection line 512 by way of a hitch. A loop can be formed on each end 524, 528 of the resilient band 522 by applying a glue to each end. The resilient band 522 is then placed underneath the mid-span portion 526 of the gas connection line 512, the loop of the first end 524 is passed through the loop on the second end 528, and the second end is pulled upwards to tighten the hitch. Alternatively, instead of glue, the working end 524 of the hitch may be secured to the standing part using one or more zip ties. Similar to the illustrated embodiment of FIG. 8, an opposing second end 528 of the resilient band 522 is secured to a stationary structure 544 at a height above first end 524. In the illustrated example, the second end 528 of the resilient band 522 is attached to the wall 506 using a hook 532. For ease of installation and to prevent drilling holes, the hook 532 may be of the variety having an adhesive backing.

In operation, the elevation apparatus 500 works much the same way as the elevation apparatus 100 disclosed in FIG. 5. The resilient band 522 is configured such that when the piece of equipment 502 is pulled away from the wall 506, the resilient band 522 is stretched a first tensioned length sufficient to lift the power cord 512 off the floor 504. Furthermore, when the equipment 502 is pushed back towards the wall 506, the resilient band 522 is stretched to a second tensioned length that is also sufficient to keep the power cord 512 elevated off the floor 504. In one embodiment of the invention, the second tensioned length is less than the first tensioned length, having the end result of lifting the mid-span portion 526 of the power cord 512 higher as the equipment 502 moves towards the wall. In this manner, the power cord 502 will assume a greater and greater vertical orientation and thus will readily fit into a narrow gap behind the installed equipment refrigerator 502.

One of the improvements of the disclosed elevation apparatus is that it prevents costly water damage when moving a refrigerator. The refrigerator can be pushed into place against the wall without having to check and make sure the roller elements are not interfering with the water supply line. This is particularly helpful because the pushing operation is a ‘blind’ operation; the person pushing the refrigerator cannot see the floor behind it.

Some advantages of the disclosed elevation apparatus are that it is a low cost solution that can be easily installed without the need to hire a professional plumber.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

1. An elevation apparatus for use in raising and retaining a connection line connected between a piece of moveable equipment and a stationary structure, the connection line having a first end configured to couple with the piece of moveable equipment and an opposing second end configured to couple with a supply fitting, the elevation apparatus comprising:
a resilient band having a first end and an opposing second end, the first end configured to be affixed to a mid-span portion of the connection line, and the second end configured to be stretched and affixed to an object at a height sufficient to impart a first tensioned length to the resilient band, such that the mid-span portion of the band elevates to a first vertical distance; and
a hook configured to be attached to the object and secure the second end of the resilient band.

2. The elevation apparatus according to claim 1, wherein the connection line is a refrigerator water supply line configured to connect at the first end to a water supply fitting on the refrigerator, and configured to connect at the second end to a water supply fitting at the stationary structure.

3. The elevation apparatus according to claim 1, wherein the connection line is an electrical power cord connected at the first end to the piece of moveable equipment, and configured at the second end to plug into a wall socket.

4. The elevation apparatus according to claim 1, wherein the connection line is a gas connection line configured to connect to gas supply fitting at the first end, and configured to connect to a stationary gas supply fitting at the second end.

5. The elevation apparatus according to claim 1, wherein the second end of the resilient band is configured to be affixed to the piece of moveable equipment.

6. The elevation apparatus according to claim 1, wherein the second end of the resilient band is configured to be affixed to the stationary structure.

7. The elevation apparatus according to claim 1, wherein lateral movement of the piece of equipment from a first position away from the stationary structure to a second position towards the stationary structure stretches the resilient band to a second tensioned length.

8. The elevation apparatus according to claim 7, wherein the first tensioned length is greater than the second tensioned length.

9. The elevation apparatus according to claim 1, wherein the resilient band comprises neoprene rubber having a stretch ratio of at least 180%.

10. The elevation apparatus according to claim 9, wherein the neoprene rubber has a width in a range between approximately ⅛-inch and ½-inch.

11. The elevation apparatus according to claim 10, wherein the neoprene rubber has a textured surface to provide better grip with the connection line.

12. The elevation apparatus according to claim 1, wherein the ends of the resilient band are formed into a loop.

13. An elevation apparatus, comprising:
a connection line having a first end configured to connect to a fitting on a piece of moveable equipment, and an opposing second end configured to connect to a stationary supply source; and
a resilient band having a first end and an opposing second end, the first end configured to be affixed to a mid-span portion of the connection line, and the second end configured to be stretched and affixed to an object at a height sufficient to impart a first tensioned length to the resilient band, such that the mid-span portion of the band elevates to a first vertical distance.

14. The elevation apparatus according to claim 13, wherein the connection line comprises a braided stainless steel outer sheathing and inner nylon-reinforced vinyl tubing.

15. The elevation apparatus according to claim 13, wherein the resilient band comprises neoprene having a textured surface to provide better grip with the connection line.

16. The elevation apparatus according to claim 13, wherein the resilient band has a stretch ratio of at least 180%.

17. The elevation apparatus according to claim 13, wherein the first end of the resilient band is configured to couple to the mid-span portion of the connection line by a hitch.

18. An elevation apparatus configured to elevate an electrical power cord on a piece of equipment moveable from a first position away from a stationary structure to a second position towards the stationary structure, the elevation apparatus comprising a resilient band having a first end and an opposing second end, the first end configured to be coupled to a mid-span portion of the electrical power cord, and the second end configured to be coupled to the piece of equipment at a distance sufficient to impart a first tensioned length to the resilient band, such that the mid-span portion of the electrical power cord elevates to a first vertical distance.

19. The elevation apparatus according to claim 18, wherein movement of the piece of equipment from the first position to the second position elevates the mid-span portion of the flexible supply line to a second, higher vertical distance.
